(19) United States
(12) Patent Application Publication
(10) Pub. No.: US 2016/0050723 A1
(43) Pub. Date: Feb. 18, 2016

(54) SYSTEM ARCHITECTURE OF A TUNABLE LAMP SYSTEM

(71) Applicant: LUMENETIX, INC., Scotts Valley, CA (US)

(72) Inventors: Daniel Gochnauer, Saratoga, CA (US); Yaron Rosenbaum, Santa Cruz, CA (US); Jay Hurley, Watsonville, CA (US); Alex Lynchosky, Santa Cruz, CA (US); Thomas Poliquin, Aptos, CA (US); James Kingman, Woodside, CA (US); Sanjoy Ghose, Scotts Valley, CA (US)

(21) Appl. No.: 14/458,457

(22) Filed: Aug. 13, 2014

(51) Int. Cl. H05B 33/08; H05B 37/02

(52) U.S. Cl. CPC H05B 33/086; H05B 33/0869; H05B 37/0227; H05B 37/0281

(57) ABSTRACT

Some embodiments of this disclosure operate a LED-based lamp module in conjunction with a controller, such as a general-purpose mobile device or other light control system. The operations can include producing light at a current correlated color temperature (CCT) from a light source comprising an LED set of different color LEDs; authenticating a connection between a mobile device and the LED-based lamp module; receiving a target CCT for the LED-based lamp module; determining a target LED driving condition that produces the target CCT based on a color mixing plan stored in the LED-based lamp module; and adjusting the current CCT towards the target CCT by adjusting a current LED driving condition towards the target LED driving condition.

### RELATED FIELD

At least one embodiment of this disclosure relates generally to a tunable lighting system, and in particular to controlling tunable LED-based lamp modules.

### BACKGROUND

Conventional systems for controlling lighting in homes and other buildings suffer from many drawbacks. One such drawback is that these systems rely on conventional light sources, such as incandescent bulbs and fluorescent bulbs. Such light sources are limited in many aspects. For example, such light sources typically do not offer long life or high energy efficiency. Further, such light sources offer only a limited selection of colors, and the color or light output of such light sources typically changes or degrades over time as the bulb ages. In systems that do not rely on conventional lighting technologies, such as systems that rely on light emitting diodes (“LEDs”), long system lives are possible and high energy efficiency can be achieved. However, in such systems issues with color quality can still exist.

A light source can be characterized by its color temperature and by its color rendering index (“CRI”). The color temperature of a light source is the temperature at which the color of light emitted from a heated black-body radiator is matched by the color of the light source. The color temperature is useful to emulate different states of natural light produced from the sun. For a light source that does not substantially emulate a black body radiator, such as a fluorescent bulb or an LED, the correlated color temperature (“CCT”) of the light source is the temperature at which the color of light emitted from a heated black-body radiator is approximated by the color of the light source. The CRI of a light source is a measure of the ability of a light source to reproduce the colors of various objects faithfully in comparison with an ideal or natural light source. The CCT and CRI of LED light sources are typically difficult to tune and adjust. Further difficulty arises when trying to maintain an acceptable CRI while varying the CCT of an LED light source.

### DISCLOSURE OVERVIEW

Disclosed is a system architecture of configuring a lamp system to accurately and consistently produce light in accordance with a user setting. The lamp system can include one or more tunable light modules, such as LED-based lamp modules. The tunable light modules can be independently replaceable. The lamp system is able to produce a target light characteristic (e.g., CCT, hue, saturation, brightness, or any combination thereof) based on a color mixing plan (can also be referred to as the color model). The LED-based lamp modules can each include an LED set. The LED set can include LEDs of different colors. The LED-based lamp modules can be adjusted within a wide spectrum of light characteristics by mixing light from different color LEDs and controlling the operating conditions of each of the color LEDs.

Some embodiments, a model builder system can generate a color space map of lamps (e.g., LEDs) during a manufacturing stage for a LED-based lamp module. The color space map can capture the unique characteristic of each of the LEDs in each LED-based lamp module. Because of minor differences in material and manufacturing process, not all LEDs of the same color type produce the same light characteristic under the same operating conditions. Furthermore, because of minor geometric configuration differences between LED sets and the variations amongst LEDs of the same color type, not all LED-based lamp modules produce the same light characteristics under the same operating conditions. A model builder system can generate a color mixing plan from the color space map for the LEDs in a LED-based lamp module such that the LED-based lamp module is able to reproduce a designated light characteristic on command (e.g., by determining the operating conditions necessary to achieve such light characteristic).

For example, the model builder system can iterate through different operating conditions (e.g., different operating temperatures and different driving currents) for each of the LED set when building a color space map. In some embodiments, the model builder system can monitor the color characteristics using a spectrum analyzer while iterating through the different operating conditions. From the color space map of the LEDs, the model building system can compute a color mixing plan. This way, the model builder system is able to identify operating conditions for meeting different CCT values while optimizing for brightness (e.g., lumens) or efficacy (e.g., low power consumption). The model builder system can further identify operating conditions for meeting different CCT values while optimizing for expected life span of the LED-based lamp module. For example, based on experimental data, the model builder system can identify certain LED of a particular color type that has a shorter operating lifespan than the others. The model builder system can then optimize by minimizing operating conditions that will be speed up degradation of the particular color type (e.g., by sacrificing other color types that has a longer operating life span).

A color mixing plan is a set of associations that specifies how to achieve different characteristics of the output illumination under a given operational condition and given constraints of performance metrics. The set of associations can be stored as a reference table (more memory intensive) or a polynomial function (more processor intensive). For example, a color mixing plan can specify driving conditions (e.g., current levels and/or signal patterns, such as different pulse width modulations) or luminous flux for or from each of the lamps to achieve a color characteristic (e.g., CCT) at a particular operational temperature. The operational condition may include a junction temperature, a mixing chamber temperature, a heat sink temperature, or a combination thereof. The constraints can include an efficacy constraint, an efficiency constraint, a maximum brightness constraint (e.g., per color channel or overall), CRI constraints, or any combination thereof.

A mobile device can be coupled to one or more LED-based lamp modules to establish a lamp group. In that case, the lamp system is comprised of the mobile device and the LED-based lamp modules in the lamp group. The mobile device can be a general purpose device having an operating system implemented thereon (e.g., by a processor executing executable instructions stored in a memory component). The operating system can enable the mobile device to download, install, and implement a light control application thereon.

The light control application provides a user interface (e.g., a touchscreen interface) for a user to configure an LED-based lamp module or the lamp group as a whole. The light control application can control the LED-based lamp modules via wireless protocols (e.g., Bluetooth or WiFi). For example, the LED-based lamp modules can include an integrated communication module therein, or be coupled to an adapter box that receives and interprets the communication from the light control application. The LED-based lamp has the capability of color matching color spectrums and calibrating its correlated color temperatures, brightness, and hue based on the color mixing plan. The light control application can send or schedule commands actively (e.g., based on a user command) or passively (e.g., automatically as a background process without a user command) to activate the color matching and calibration process on the LED-based lamp. The light control application can further receive status information regarding the LED-based lamp including fault detection, estimated life time, temperature, power consumption, or any combination thereof.

In some embodiments, the light control application can initiate (e.g., automatically or based on a user command) a lamp maintenance process, including re-calibration and data collection. For example, the light control application can communicate (e.g., via WiFi or cellular data plan) with a computer server that stores light configuration data (e.g., CCT, brightness, saturation, and/or hue) and operating state data (e.g., temperature, current, actual CCT level, or other light characteristic data from sensors of a lamp module) for each of the lamp group or lamp modules. The computer server can re-compute and/or re-optimize a color mixing plan for a lamp module based on the recorded history of operating state data and light configuration data. The computer server can then push the updated color mixing plan back to the lamp module through the mobile device running the light control application. In some embodiments, the computer server, the light control application, the lamp module, or a combination thereof, can maintain the recorded history of configuration data and operating state data of the lamp module.

In some embodiments, instead of controlling the LED-based lamp modules with a general-purpose mobile device, a controller device coupled to the LED-based lamp modules via a wired interconnect can also control the LED-based lamp modules. For example, the controller device can communicate directly through the wired interconnect with an integrated communication module in a LED-based lamp or indirectly through an adapter box outside of the LED-based lamp that interprets and/or converts the control signal from the controller device.

Some embodiments of this disclosure have other aspects, elements, features, and steps in addition to or in place of what is described above. These potential additions and replacements are described throughout the rest of the specification

### BRIEF DESCRIPTION OF THE DRAWINGS

FIG. 1 illustrates a configurable lamp system, in accordance with various embodiments.

FIG. 2A is a block diagram of a first example architecture for controlling a configurable lamp system, in accordance with various embodiments.

FIG. 2B is a block diagram of a second example architecture for controlling a configurable lamp system, in accordance with various embodiments.

FIG. 3 is a block diagram of a LED-based lamp module, in accordance with various embodiments.

FIG. 4 is an example of a first screenshot of a user interface implemented on a mobile device to control a configurable lamp system, in accordance with various embodiments.

FIG. 5 is an example of a second screenshot of a user interface implemented on a mobile device to control a configurable lamp system, in accordance with various embodiments.

FIG. 6 is a flow chart of a method of operating a LED-based lamp, in accordance with various embodiments.

FIG. 7 is a diagrammatic representation of a machine in the example form of a computer system within which a set of instructions, for causing the machine to perform any one or more of the methodologies or modules discussed herein, may be executed.

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

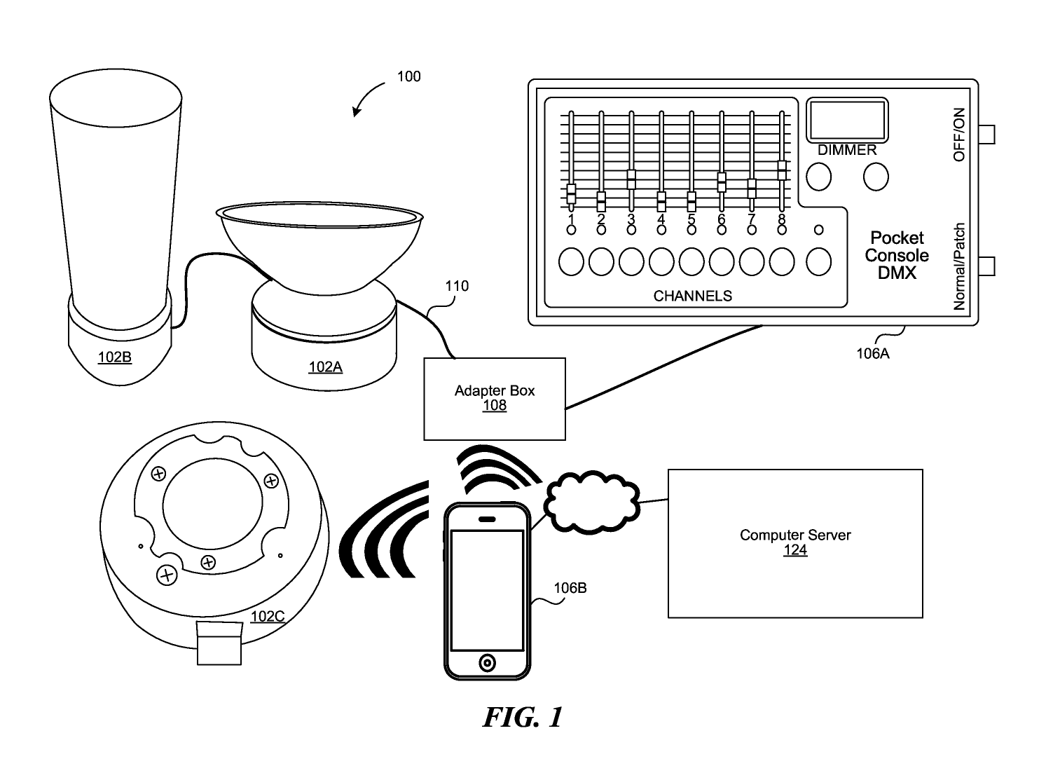

FIG. 1 illustrates a configurable lamp system 100, in accordance with various embodiments. The configurable lamp system 100 includes one or more LED-based lamp modules (e.g., a lamp module 102A, a lamp module 102B, and a lamp module 102C, collectively as the “lamp modules 102”). The lamp modules 102 may produce directional light, linear light (e.g., light along a curved or straight line), collimated light, spot light, multidirectional light, omnidirectional light (e.g., point light source), or other geometries. In some embodiments, the lamp modules 102 can be configured with different modular covers (e.g., a light collector cover 104A or a diffuser cover 104B, collectively as the “lamp module covers 104”). The lamp modules 102 can be independently replaceable. The configurable lamp system 100 is able to produce a target light characteristic (e.g., CCT, hue, saturation, brightness, or any combination thereof) in response to receiving a light tuning command utilizing a color mixing plan. The lamp modules 102 can each include an LED set. The LED set can include LEDs of different colors.

The lamp modules 102 may be configured with one or more mechanisms for communicating with an external control device. For example, the lamp modules 102 can communicate with a wired controller 106A via an adapter box 108. The wired controller 106A, for example, can be a DMX control box. The adapter box 108 is configured to convert communication signal between different communication protocols (e.g., DMX, Lutron, Zigbee Light Link, digital addressable lighting interface (DALI), Bluetooth, Bluetooth LE, etc.). The adapter box 108 can be configured for wired communication, wireless communication, or both. For example, the adapter box 108 may connect with at least a subset of the lamp modules 102 via a wired connection and communicate with the wired controller 106A via a different wired connection. In another example, the adapter box 108 may connect with at least a subset of the lamp modules 102 via a wireless protocol (e.g., Bluetooth LE) and communicate with the wired controller 106A via a wired connection or a wireless controller 106B via a wireless connection (e.g., Bluetooth, Wi-Fi or Wi-Fi direct).

In some embodiments, one or more of the lamp modules 102 can also communicate directly with a wireless controller 106B via a wireless protocol. These lamp modules can include an internal wireless module to communicate directly with the wireless controller 106B. Alternatively, these lamp modules can communicate wirelessly through the adapter box 108. The adapter box 108 can be configured for digital to digital communication (i.e., digital to/from the lamp modules 102 and digital to/from the wireless controller 106B), digital to analog communication (i.e., digital to/from the lamp modules 102 and analog to/from the wireless controller 106B), analog-to-digital communication (i.e., analog to/from the lamp modules 102 and digital to/from the wireless controller 106B), or analog to analog communication (i.e., analog to/from the lamp modules 102 and analog to/from the wireless controller 106B). In a preferred embodiment, the adapter box 108 is configured to communicate digitally to the lamp modules 102 to provide precise numeric values of light characteristics. In some embodiments, the adapter box 108 is configured to communicate with a 0 to 10V dimmer acting as the wired controller 106A, and hence, takes in an analog signal that is then converted to a digital command to the lamp modules 102.

Further, the adapter box 108 can include one or more channels of communication to each of the lamp modules 102. At least one of the channels can provide color temperature control. At least one of the channels can provide brightness control. At least one of the channels can provide hue control. At least one of the channels can provide saturation control.

The adapter box 108 may be connected to the lamp modules 102 via the interconnect 110. In some embodiments, the adapter box 108 can be connected to multiple interconnects to relay commands to and data from multiple groups of lamp modules. The interconnect 110 can serially linked together one or more of the lamp modules 102 such that a single connection of the interconnect 110 to the adapter box 108 enables the wired controller 106A or the wireless controller 106B to control every one of the lamp modules 102 connected to the interconnect 110. The interconnect 110, for example, can be a RS485 bus.

In some embodiments, the adapter box 108 can draw power from a wired connection to the wired controller 106A, from a wired connection (e.g., the interconnect 110) to one of the lamp modules 102, or both. In some embodiments, the adapter box 108 can have its own power source. In some embodiments, the adapter box 108 can draw power from a wired connection to supplement power drawn from an internal power source or vice versa.

In some embodiments, the wired controller 106A or the wireless controller 106B can be connected to a core network (e.g., the Internet), such as through a network equipment (e.g., a wireless WiFi router) or a cellular Internet provider (e.g., LTE, 3G, etc.). A computer server 124 in the core network can implement a light control service that is accessible by the wired controller 106A or the wireless controller 106B. The wired controller 106A or the wireless controller 106B, for example, can implement a user interface for controlling the lamp modules 102. One or more of the functionalities of the wired controller 106A or the wireless controller 106B can be assisted by the light control service, including re-calibration, maintenance, storage of color mixing plan, storage of light adjustment history, storage of lamp module groups, storage of user preference of light settings, storage of conditional rules associated with light settings (e.g., automatically sending light tuning commands based on an observable context at one or more of the lamp modules 102), etc.

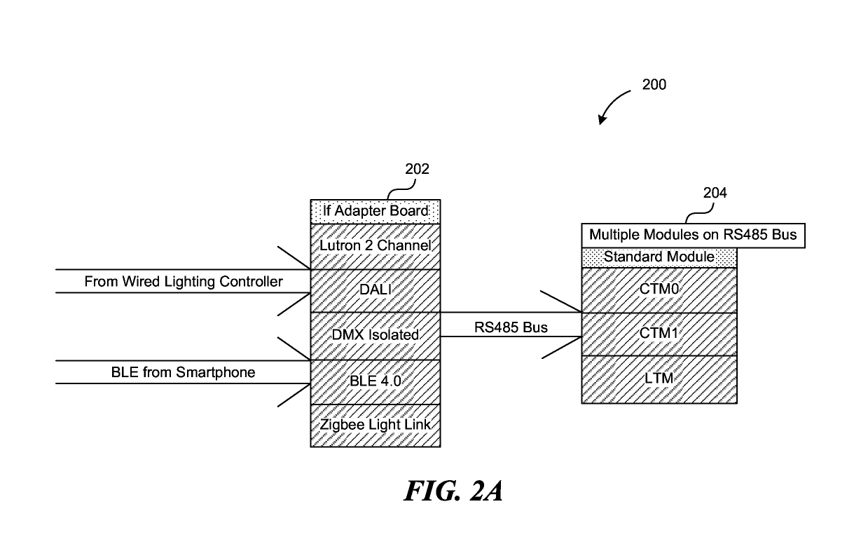

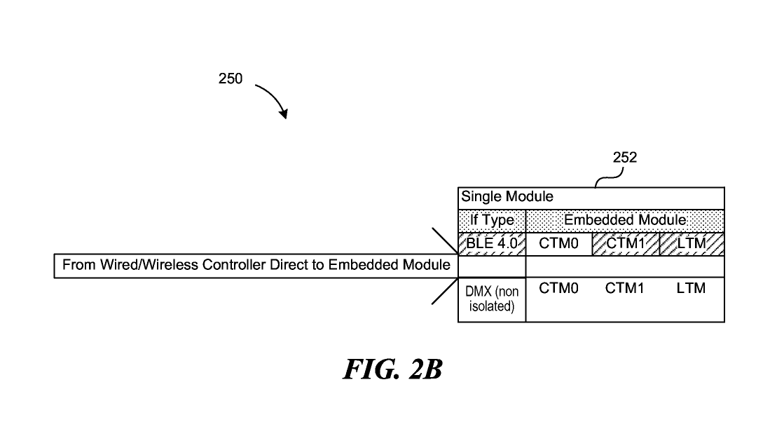

FIG. 2A is a block diagram of a first example architecture for controlling a configurable lamp system 200 (e.g., the configurable lamp system 100), in accordance with various embodiments. For example, the configurable lamp system 200 includes an adapter board 202, such as the adapter box 108 of FIG. 1, for controlling multiple lamp modules 204 (e.g., the lamp modules 102 of FIG. 1). The adapter board 202 can receive inputs from a wired lighting controller via a Lutron 2 channels protocol, a DALI protocol, an isolated DMX (i.e., grounded) protocol, a Zigbee Light Link protocol, or any combination thereof. The adapter board 202 can also receive inputs from a smart phone via Bluetooth, such as Bluetooth LE 4.0. The lamp modules 204 can be daisychained using a RS-485 bus. The lamp modules 204 can be of the same type or of different types (e.g., a color tunable point light source, a color tunable linear light source, or a color tunable collimated light source).

FIG. 2B is a block diagram of a second example architecture for controlling a configurable lamp system 250 (e.g., the configurable lamp system 100), in accordance with various embodiments. The configurable lamp system 250 includes a lamp module 252 (e.g., one of the lamp modules 102 of FIG. 1). The lamp module 252 has an integrated Bluetooth interface and/or non-isolated DMX interface. The lamp module 252 is advantageous in that no additional adapter hardware is necessary to provide color tuning (e.g., accurate and consistent color temperature tuning) capabilities. The lamp module 252 is also advantageous when used in a group. For example, multiple lamp modules, such as the lamp module 252, can be wirelessly configured to function as a group by a smart phone regardless of how close or apart they are.

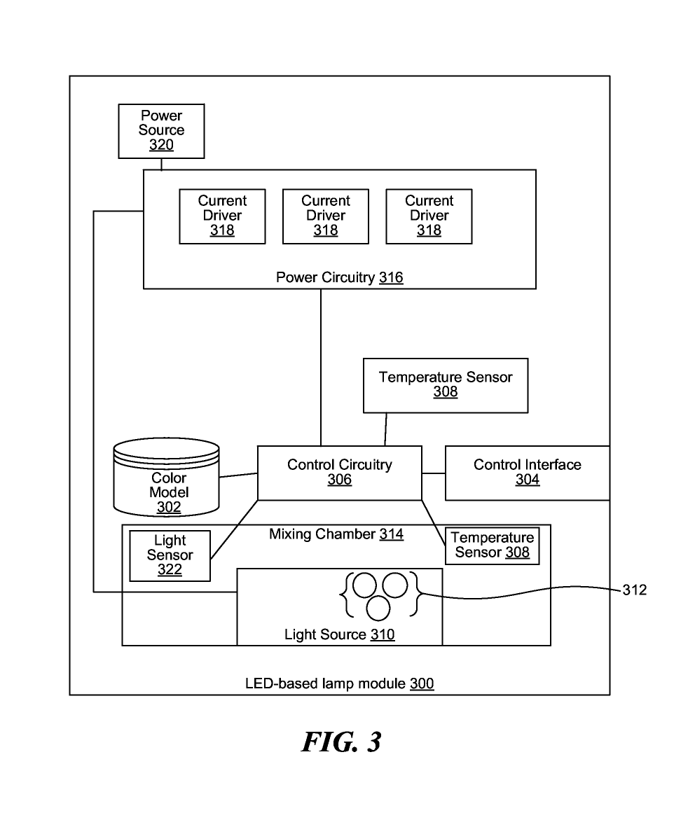

FIG. 3 is a block diagram of a LED-based lamp module 300, in accordance with various embodiments. The LED-based lamp module 300 includes a color model store 302, a control interface 304, a control circuitry 306, a temperature sensor 308, a light source 310 comprising different color LEDs 312, a mixing chamber 314, power circuitry 316 including current drivers 318 for the color LEDs 312, a power source 320, a light sensor 322, or any combination thereof. The color model store 302 is a memory device or a portion of a memory device for storing a color mixing plan as defined above.

The control interface 304 can include a hardware port for a wired connection or a radio antenna for establishing wireless communication. In some embodiments, the control interface 304 can include multiple radio antennas, such as one for transmitting and one for receiving. The control interface 304 can execute communication protocol instructions for formatting a signal (e.g. a digital or an analog signal) to transmit through the hardware port or the radio antenna. Likewise, the control interface 304 can execute the communication protocol instructions to interpret a signal (e.g., a digital or analog signal) received through the hardware port or the radio antenna. The communication protocol instructions, for example, can be implemented by a processor configured with software executable instructions. These executable instructions can be stored in a memory device, such as the same memory device as the color model store 302 or another memory device. For another example, the instructions can be implemented by application-specific integrated circuit, a programmable controller, field programmable gate array (FPGA), other digital or analog circuitry, or any combination thereof.

The control circuitry 306 executes control instructions to operate the LED-based lamp module 300. The control circuitry 306 can execute light tuning commands received through the control interface 304. For example, the control circuitry 306 can determine adjustment commands to the power circuitry 316 including the current drivers 318. The control circuitry 306 can also detect context of information within the LED-based lamp module 300. For example, the control circuitry 306 can determine the context via measurements taken from the temperature sensor 308, the light sensor 322, power measurement circuit (e.g., for voltage or current) in the power circuitry 316, or any combination thereof. The control circuitry 306 can generate and implement a schedule to report context information and sensor measurements to the controller via the control interface 304.

The control circuitry 306 can execute various other user-initiated, conditional (i.e., a background/passive command triggered when a contextual condition is detected), or scheduled commands (i.e., a background/passive command executed sua sponte by the control circuitry 306 in accordance with a schedule). Such commands can include a calibration command, a light maintenance or testing command, a light effect sequence command (i.e., executing a series of light/color tuning commands in accordance with a preset sequence or schedule), an optical/visual communication command (e.g., executing a light effect sequence and/or monitoring for a nearby light effect sequence for the purpose of communication), or any combination thereof. The optical/visual communication command can be configured for optical/visual communication between lamp modules (e.g., digital communication), or between the LED-based lamp module 300 and a nearby person (e.g., human understandable communication).

The control circuitry 306 can communicate with a light control application, in real time or asynchronously, running on a controller connected through the control interface 304. In some embodiments, the control circuitry 306 can communicate with a light control service, in real time or asynchronously, provided by a computer server. The control circuitry 306 and the light control service can relay its back and forth communications through the controller.

In some embodiments, the control interface 304 can receive commands to reconfigure the communication protocol portion of the control interface 304 (e.g., via reconfiguring the instructions for execution by the control interface 304). In some embodiments, the control interface 304 can receive commands to reconfigure or update the control logics of the control circuitry 306 (e.g., via reconfiguring the instructions for execution by the control interface 304).

The control circuitry 306 can use the temperature sensor 308 to measure or approximate an operating temperature of the light source 310. In order to provide accurate and consistent color characteristics, the control circuitry 306 uses the color mixing plan in the color model store 302 to determine the proper operating conditions (e.g., driving currents to the color LEDs 312) to achieve the target light characteristics. The color mixing plan, for example, can associate light characteristics and/or operating temperature to driving currents and/or luminous flux of the color LEDs 312. Hence, the control circuitry 306 can use the temperature sensor 308 to determine the operating temperature at the light source 310. In some embodiments, because the color LEDs 312 in the light source 310 are so small and closely packed that it is difficult to place the temperature sensor 308 at the light source 310, the temperature sensor 308 is placed at a different location to approximate the operating temperature. For example, the temperature sensor 308 can be located at a heat sink of the light source 310 or a temperature pad. In some embodiments, when the LED-based lamp module 300 is manufactured, a model builder system (i.e., a computer system configured to model behaviors of the LED-based lamp module 300) that generates a color mixing plan can also build a temperature variation model. The temperature variation model can map an observed temperature at the temperature sensor 308 to the actual operating temperature of the color LEDs 312. In some embodiments, the temperature variation model can also approximate the operating temperature based on driving currents and/or running time of the color LEDs 312.

When executing a command to adjust a light characteristic of one of the color LEDs 312, the control circuitry 306 can implement a jitter avoidance mechanism when adjusting the driving current of the color LED. A visual “jitter” is an observable unsteady variance or noise when a person is observing the LED-based lamp module 300 executing an adjustment of the light characteristic in discrete steps. The jitter avoidance mechanism computes discrete steps in adjusting the driving current such that the person is unable to observe the visual jitter. For example, this can be achieved by having finer discrete steps or creating discrete steps in a pattern to emulate continuous adjustment.

The light source 310 can comprise the different color LEDs 312. The color LEDs 312 enables the light source 310 to produce a wide range of color temperature, brightness, hue, and saturation. For example, mixing the light produced by the color LEDs 312 can produce near-white light that emulates a blackbody radiator, such as the sun. The light source 310 is advantageous because it enables sensors to provide instant feedback from a single location for all the color LEDs 312. For example, this is useful to use the light sensor 322 for a re-calibration process. The light sensor 322 can be a PIN diode, a tri-stimulus sensor (e.g., a colorimeter), or a spectrum analyzer.

The mixing chamber 314 is an optical component around the light source 310 to manipulate the light produced from the light source 310. The mixing chamber 314 can collect the light. For example, the mixing chamber 314 can have a portion to collect the light using a shell with a reflective inner surface. The inner reflective surface can be a reflective coating. Alternatively, the shell can be of a material with a high refractive index that causes total internal reflection at the majority of incident angles from the light collection portion of the shell or the color LEDs 312.

The shell can have at least a close end adjacent to and under the light source 310 (e.g., where the light source 310 sits on a circuit board, the close end can be under the circuit board). In some embodiments, the close end can have a reflective surface as well. The mixing chamber 314 can be narrowest around the close end and expands in size away from the light source 310. For example, the shell can be a parabolic shape to collect the light. The parabolic shell can surround the light source 310 to collect the omnidirectional light and pipe it at a direction away from the close end.

The mixing chamber 314 can have a portion to mix the light, including patterns on the shell to promote light rays from the different color LEDs 312 to mix with each other. The portion to mix light can mix the light without changing the directionality of the light rays that are moving away from the light source 310 (e.g., mixing the light on a plane perpendicular to the direction of the light rays from the light source 310). The mixing chamber 314 can have a portion to collimate or redirect the light outside of the shell. The mixing chamber 314 can have an exit aperture in the shell to output the light from the shell. In some embodiments, the mixing chamber 314 can be supplemented with a modular cover. The modular cover can be used to further manipulate the light, including acting as a diffuser, light direction changer, or filter.

The power circuitry 316 includes the current drivers 318 for the color LEDs 312. The power circuitry 316 draws power from the power source 320, which can be a battery or a DC power supply that converts AC power to DC. The current drivers 318 are coupled to the control circuitry 306. Each of the current drivers 318 can control at least one of the color LEDs 312. The control circuitry 306 can command each of the current drivers 318 to drive its respective LED at a particular current level.

Portions of components (e.g., circuitry, storage, sensors, etc.) associated with the LED-based lamp module 300 may each be implemented in the form of special-purpose circuitry, in the form of one or more appropriately programmed programmable processors, a single board chip, a field programmable gate array, a network capable computing device, a virtual machine, a cloud-based terminal, or any combination thereof. For example, the components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not transitory signal. Memory space and storages described in the figures can be implemented with the tangible storage memory as well, including volatile or non-volatile memory.

Each of the components may operate individually and independently of other components. Some or all of the components may be executed on the same host device or on separate devices. The separate devices can be coupled together through one or more communication channels (e.g., wireless or wired channel) to coordinate their operations. Some or all of the components may be combined as one component. A single component may be divided into sub-components, each sub-component performing separate method step or method steps of the single component.

In some embodiments, at least some of the components share access to a memory space. For example, one component may access data accessed by or transformed by another component. The components may be considered “coupled” to one another if they share a physical connection or a virtual connection, directly or indirectly, allowing data accessed or modified from one component to be accessed in another component. In some embodiments, at least some of the components can be upgraded or modified remotely (e.g., by reconfiguring executable instructions that implements a portion of the components). The LED-based lamp module 300 may include additional, fewer, or different components for various applications.

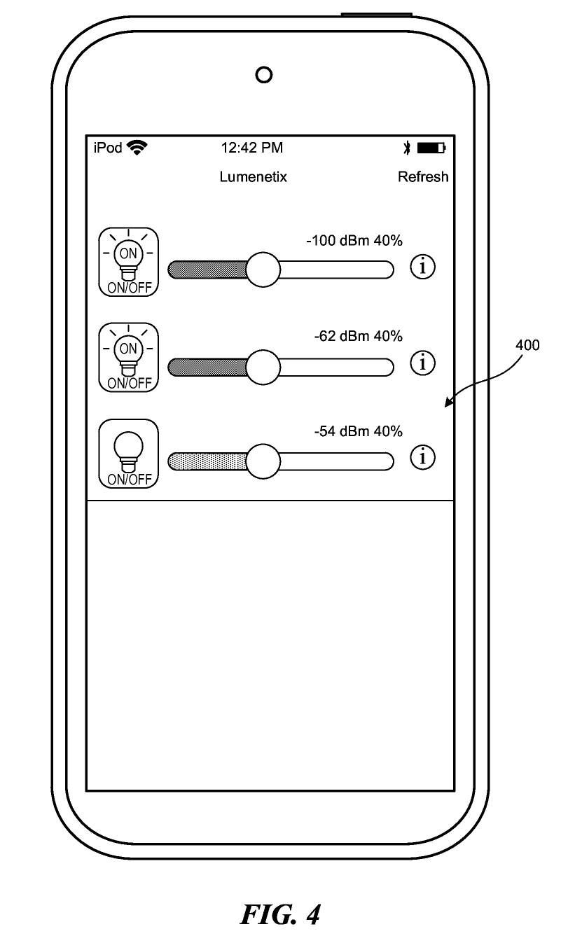

FIG. 4 is an example of a first screenshot of a user interface 400 implemented on a mobile device (e.g., the wireless controller 106B of FIG. 1) to control a configurable lamp system (e.g., the configurable lamp system 100 of FIG. 1), in accordance with various embodiments. The user interface 400 provides interactive components for a user of the mobile device to control one or more lamp modules in the configurable lamp system. For example, the mobile device can detect and list connected or connectable lamp modules in its proximity. For example, the user interface can list one or more lamp modules that are already connected (e.g. via a wired interconnect or wireless connection). For example, the mobile device can scan for and discover the modules with Bluetooth capability (e.g., integrated Bluetooth capability or Bluetooth capability provided through an adapter box, such as the adapter box 108 of FIG. 1). Through the user interface 400, the user can select a group of the lamp modules to control simultaneously (e.g., by issuing the same command or issuing commands that are relative to one another. The same command, for example, can adjust all of the lamp modules in the group to a designated CCT level. Commands relative to one another, for example, can adjust the lamp modules from their respective CCT levels to a designated CCT level such that the speed of such adjustment is configured for the lamp modules to reach the designated CCT level at the same time.

The user interface 400 can be coupled to a lamp control server, such as the computer server 124 of FIG. 1. The lamp control server can store configuration information of lamp modules. For example, after a mobile device authenticates a lamp module or vice versa, the mobile device can report identifying information of the lamp module to the lamp control server. Preferences and designated light characteristics of the lamp can be stored in the lamp control server. Group information and user profile information (e.g., the user of the user interface 400) associated with the lamp module can also be stored in the lamp control server. The user profile can also be stored independent of a lamp module. For example, a user profile can store a preferred light effect schedule (e.g., turning the lamp module on to a first CCT level at 8 AM and re-adjusting to a second CCT level at 10 AM) regardless of which lamp module the user interface 400 controlling.

The lamp control server can also maintain maintenance-related information of the lamp module. For example, the lamp control server can track the degradation levels of each LED in the lamp module. The lamp control server can re-compute the color mixing plan for each lamp module for the purpose of recalibration. Subsequently, the lamp control server can update the color mixing plan or other control logic to the lamp module.

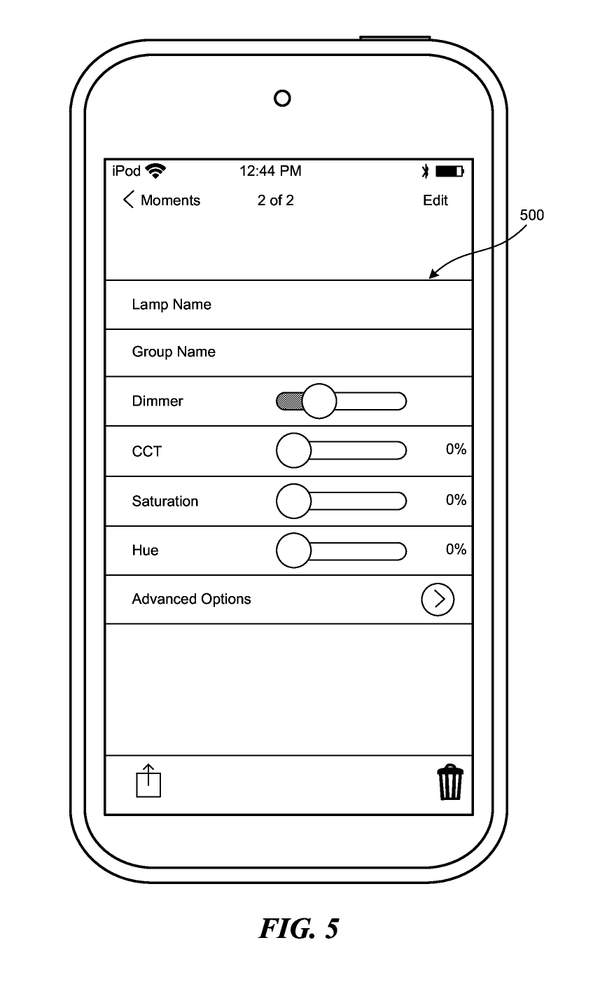

The first screenshot illustrates an example of a group control interface for three lamp modules. A user can turn the lamp modules on and off through the user interface 400. The first screenshot also illustrates interactive sliders for adjusting a light characteristic (e.g., the brightness level) of the lamp modules. Further, the user interface 400 is illustrated to show information relating to the designated light characteristic (e.g., the brightness level in dBm or percentage). The first screenshot also illustrates an individual lamp module button (e.g., illustrated as the circled letter “i”). In some embodiments, by pressing on the individual lamb module button, the user interface 400 takes the user to the second screenshot illustrated in FIG. 5.

FIG. 5 is an example of a second screenshot of a user interface 500 implemented on a mobile device (e.g., the wireless controller 106B of FIG. 1) to control a configurable lamp system (e.g., the configurable lamp system 100 of FIG. 1), in accordance with various embodiments. The user interface 500 can be the user interface 400 of FIG. 4. The second screenshot illustrates an interface page on the mobile device for controlling an individual lamp module. For example, the user can designate a lamp name for the lamp module and a group name for the lamp module. If the lamp module is designated with a group name matching that known to the mobile device or a cloud-based server (e.g., the computer server 124), a group control interface (e.g., the first screenshot of FIG. 4) would become available through the mobile device to control the lamp group.

The interface page can include a dimmer component for adjusting the brightness. For example, the dimmer component can be an interactive slider. The interface page can include a CCT component for adjusting the color temperature of the lamp module. For example, the CCT component can also be an interactive slider. Likewise, the interface page can further include a saturation adjustment component and a hue adjustment component, both of which can be interactive sliders.

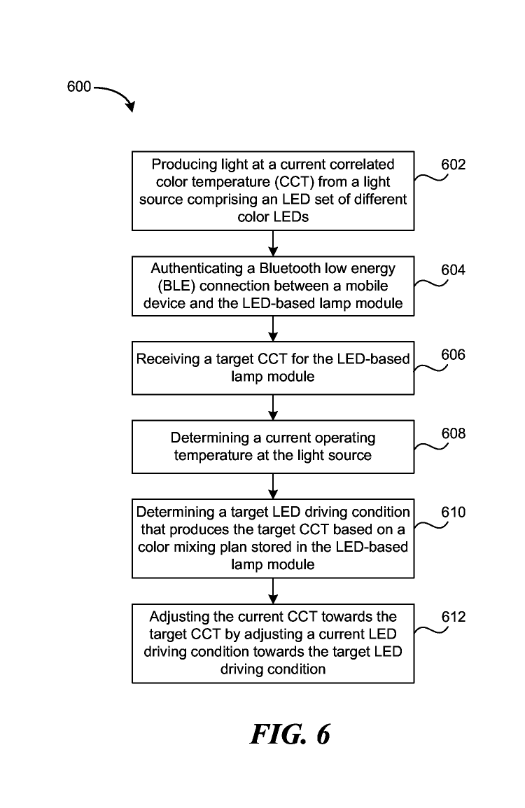

FIG. 6 is a flow chart of a method 600 of operating a LED-based lamp (e.g., the LED-based lamp module 300 of FIG. 3), in accordance with various embodiments. The method 600 can include step 602 of the LED-based lamp producing light at a current correlated color temperature (CCT) from a light source (e.g., point light source) comprising an LED set of different color LEDs. Then at step 604, the LED-based lamp can authenticate a Bluetooth low energy (BLE) connection between a mobile device and the LED-based lamp module. At step 606, the LED-based lamp receives a target CCT for the LED-based lamp module.

At step 608, the LED-based lamp determines a current operating temperature at the light source. Determining the current operating temperature may include measuring a junction temperature of the light source using a thermal sensor in the LED-based lamp module. Determining the current operating temperature may include measuring a temperature level at a heat sink of the light source using a thermal sensor in the LED-based lamp module. Determining the current operating temperature may include measuring a temperature level at a temperature pad of the light source using a thermal sensor in the LED-based lamp module. Determining the current operating temperature may include estimating the current operating temperature based on a temperature variation model and a measured parameter (e.g., current level, lamp running time, or a temperature reading at another part of the LED-based lamp, etc.).

At step 610, the LED-based lamp determines a target LED driving condition that produces the target CCT based on a color mixing plan stored in the LED-based lamp module. Determining the target LED driving condition may include determining driving current levels to each of the color LEDs. Determining the target LED may be based on the current operating temperature. At step 612, the LED-based lamp adjusts the current CCT towards the target CCT by adjusting a current LED driving condition towards the target LED driving condition.

While processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

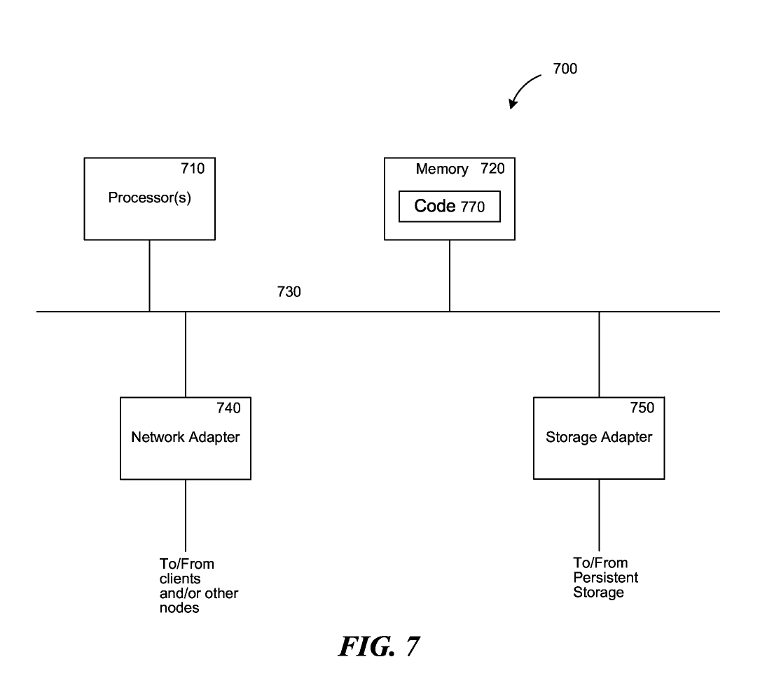

FIG. 7 is a block diagram of an example of a computing device 700, which may represent one or more computing device or server described herein, in accordance with various embodiments. The computing device 700 can represent the wired controller 106A, the wireless controller 106B or the computer server 124 of FIG. 1. The computing device 700 includes one or more processors 710 and memory 720 coupled to an interconnect 730. The interconnect 730 is an abstraction that represents any one or more separate physical buses, point-to-point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 710 is/are the central processing unit (CPU) of the computing device 700 and thus controls the overall operation of the computing device 700. In certain embodiments, the processor(s) 710 accomplishes this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 720 is or includes the main memory of the computing device 700. The memory 720 represents any form of random access memory (RAM), read-only memory (ROM), flash memory, or the like, or a combination of such devices. In use, the memory 720 may contain a code 770 containing instructions according to the mesh connection system disclosed herein.

Also connected to the processor(s) 710 through the interconnect 730 are a network adapter 740 and a storage adapter 750. The network adapter 740 provides the computing device 700 with the ability to communicate with remote devices, over a network and may be, for example, an Ethernet adapter or Fibre Channel adapter. The network adapter 740 may also provide the computing device 700 with the ability to communicate with other computers. The storage adapter 750 allows the computing device 700 to access a persistent storage, and may be, for example, a Fibre Channel adapter or SCSI adapter.

The code 770 stored in memory 720 may be implemented as software and/or firmware to program the processor(s) 710 to carry out actions described above. In certain embodiments, such software or firmware may be initially provided to the computing device 700 by downloading it from a remote system through the computing device 700 (e.g., via network adapter 740).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification.

What is claimed is:

1. A method of operating an LED-based lamp module, comprising:
producing light at a current correlated color temperature (CCT) from a light source comprising an LED set of different color LEDs;
authenticating a Bluetooth low energy (BLE) connection between a mobile device and the LED-based lamp module;
receiving a target CCT for the LED-based lamp module;
determining a target LED driving condition that produces the target CCT based on a color mixing plan stored in the LED-based lamp module; and
adjusting the current CCT towards the target CCT by adjusting a current LED driving condition towards the target LED driving condition.

2. The method of claim 1, wherein receiving the target CCT includes receiving a timer that indicates when to begin adjusting the current CCT to the target CCT value; and wherein adjusting the current CCT begins as indicated by the timer.

3. The method of claim 1, further comprising receiving an update of the color mixing plan from a computer server, wherein the update is relayed through the mobile device.

4. The method of claim 1, further comprising receiving an update of control logics to determine the target LED driving condition from a computer server, wherein the update is relayed through the mobile device.

5. The method of claim 1, further comprising determining a current operating temperature at the light source; wherein determining the target LED driving condition is further based on the current operating temperature at the light source.

6. The method of claim 1, wherein determining the current operating temperature includes measuring a junction temperature of the light source using a thermal sensor in the LED-based lamp module.

7. The method of claim 1, wherein determining the current operating temperature includes measuring a temperature level at a heat sink of the light source using a thermal sensor in the LED-based lamp module.

8. The method of claim 1, wherein determining the current operating temperature includes measuring a temperature level at a temperature pad of the light source using a thermal sensor in the LED-based lamp module.

9. The method of claim 1, wherein determining the current operating temperature includes estimating the current operating temperature based on a temperature variation model and a measured parameter.

10. The method of claim 1, wherein adjusting the current CCT towards the target CCT is by adjusting in discrete steps; further comprising computing the discrete steps to avoid jitter that is visually observable by a human.

11. The method of claim 1, wherein the current LED driving condition and the target LED driving condition respectively includes current levels to power each of the color LEDs in the LED set.

12. The method of claim 1, wherein the LED-based lamp module includes an integrated Bluetooth transceiver capable of communicating with an external device via a Bluetooth protocol.

13. A method of operating a mobile device to configure a lamp module, comprising:
selecting an LED-based lamp module on a user interface of a light control application executing on an operating system of the mobile device;
authenticating a Bluetooth low energy (BLE) connection between the mobile device and the LED-based lamp module;
selecting a correlated color temperature (CCT) value for the LED-based lamp module on the user interface; and
sending the CCT value to the LED-based lamp module via the BLE connection.

14. The method of claim 13, wherein selecting the LED-based lamp module includes selecting a preset lamp group including the LED-based lamp module as a member.

15. An LED-based lamp module comprising:
a light source comprising multiple LEDs of different colors;
a control interface configured to receive a digital signal designating a correlated color temperature (CCT);
electronic circuitry configured to drive the LEDs; and
a memory device storing a color mixing plan that dictates how the electronic circuitry is to drive the LEDs at different operating temperatures to achieve different CCT levels based on efficacy or brightness constraints;
wherein the electronic circuitry is configured to drive the LEDs to produce light at the designated CCT from the light source by referencing the color mixing plan.

16. The LED-based lamp module of claim 15, wherein the control interface is a Bluetooth low energy chip.

17. The LED-based lamp module of claim 15, wherein the control interface is integrated with the electronic circuitry.

18. The LED-based lamp module of claim 15, further comprising a temperature sensor thermally coupled to the light source.

19. The LED-based lamp module of claim 15, further comprising a light sensor that provides color spectrum feedback of the produced light to the electronic circuitry.

20. The LED-based lamp module of claim 19, wherein the color spectrum feedback is a spectrum analysis of mixed light from the LEDs that are in close proximity with each other.
